(19) United States
(12) Patent Application Publication
(10) Pub. No.: US 2015/0354889 A1
(43) Pub. Date: Dec. 10, 2015

(54) Dryer Configured to Dry Agricultural Products and Associated Method

(71) Applicant: James R. Hunter, Centennial, CO (US)

(72) Inventor: James R. Hunter, Centennial, CO (US)

(21) Appl. No.: 14/124,911

(22) PCT Filed: Jun. 5, 2012
(86) PCT No.: PCT/US12/40890

§ 371 Date: Jun. 12, 2015

Related U.S. Application Data
(60) Provisional application No. 61/495,153, filed on Jun. 9, 2011.

(51) Int. Cl. F26B 3/02

(52) U.S. Cl. CPC F26B 3/02

(57) ABSTRACT

A dryer configured to dry agricultural or non-agricultural products is provided. The dryer may include a unitary source plenum that supplies air to compartments in which products are contained. Plenum conditioners may condition the air in the unitary source plenum through, for example, controlling the humidity, temperature, and flow rate of the air. Compartment conditioners may adjust the conditions of the air in each of the compartments. Thereby air may be efficiently pre-conditioned in the unitary source plenum, and then the conditions of the air may be adjusted to optimize drying of products in each of the compartments. Related methods are also provided.

### FIELD OF THE DISCLOSURE

Various embodiments of the present disclosure relate to a dryer configured to dry agricultural products. More specifically, embodiments of the present disclosure relate to a dryer comprising a unitary source plenum, one or more plenum conditioners, a plurality of compartments, and a plurality of compartment conditioners.

### BACKGROUND OF THE DISCLOSURE

In the agricultural industry seed may be harvested at moisture levels exceeding that which would permit safe long term storage. In this regard, crops may be harvested while the moisture content is high in order to help prevent reductions in quality of the seeds from, for example, insects, disease, or exposure to adverse weather. This high moisture harvesting of seed may be combined with artificial drying to bring the seeds down to an acceptable moisture level which permits safe long term storage. The drying process may occur under strictly controlled conditions in order to maximize the quality of a resulting seed product. Factors such as the rate and the temperature at which seed dries may have a large effect upon the seeds' viability and storability.

### BRIEF SUMMARY

In one embodiment a dryer configured to dry a plurality of agricultural products is provided. The dryer may comprise a plurality of compartments configured to contain the agricultural products. Further, the dryer may include one or more fans configured to produce a flow of an air. A unitary source plenum may be configured to receive the air and selectively supply the air to each of the compartments. Also, one or more plenum conditioners may be configured to control one or more conditions of the air in the unitary source plenum and received by the compartments. Additionally, a plurality of compartment conditioners may be configured to respectively adjust one or more of the conditions of the air in each of the compartments.

In some embodiments the plenum conditioners may comprise a heater and the one of the conditions controlled by the heater comprises a temperature of the air in the unitary source plenum and received by the compartments. The heater may be configured to increase the temperature of the air in the unitary source plenum and received by the compartments to a minimum desired temperature for the compartments. Further, the plenum conditioners may comprise a humidity control unit and the one of the conditions controlled by the humidity control unit comprises a specific humidity of the air in the unitary source plenum and received by the compartments. The humidity control unit may be configured to reduce the specific humidity to a desired plenum humidity and/or increase the specific humidity to a desired plenum humidity.

In some embodiments the compartment conditioners may comprise a plurality of compartment flow controllers and the one of the conditions adjusted by the compartment flow controllers comprises a flow rate of the air into each of the compartments. The dryer may include a plurality of compartment flow sensors configured to detect a speed of the air supplied to each of the compartments and/or a plurality of compartment pressure sensors configured to detect a pressure drop associated with each of the compartments. Further, the compartment flow controllers may be configured to adjust the flow rate based at least in part on a bed depth of the agricultural products in each of the compartments.

In some embodiments the compartment conditioners may comprise a plurality of temperature controllers and the one of the conditions adjusted by the temperature controllers comprises a temperature of the air in each of the compartments. Additionally, the plenum conditioners may comprise a plenum flow controller and the one of the conditions controlled by the plenum flow controller comprises a flow rate of the air in the unitary source plenum. The dryer may further include a plenum flow sensor configured to detect a speed of the air in the unitary source plenum and/or a plenum pressure sensor configured to detect a pressure of the air in the unitary source plenum.

In an additional embodiment, a method for drying a plurality of agricultural products is provided. The method may comprise containing the agricultural products in a plurality of compartments. Further, the method may include producing a flow of an air with one or more fans and selectively directing the air through a unitary source plenum to each of the compartments. Also, the method may include controlling one or more conditions of the air in the unitary source plenum and received by the compartments with one or more plenum conditioners. Additionally, the method may comprise respectively adjusting one or more of the conditions of the air in each of the compartments with a plurality of compartment conditioners.

In some embodiments controlling the conditions of the air in the unitary source plenum may comprise controlling a temperature of the air in the unitary source plenum and received by the compartments with a heater. Controlling the temperature of the air in the unitary source plenum may comprise heating the air in the unitary source plenum and received by the compartments to a minimum desired temperature for the compartments. Further, controlling the conditions of the air in the unitary source plenum may comprise controlling a specific humidity of the air in the unitary source plenum and received by the compartments with a humidity control unit. Controlling the specific humidity may comprise reducing the specific humidity to a desired plenum humidity and/or increasing the specific humidity to a desired plenum humidity.

In some embodiments adjusting the conditions of the air in each of the compartments may comprise adjusting a flow rate of the air into each of the compartments with a plurality of compartment flow controllers. Further, the method may include detecting a speed of the air through each of the compartments with a plurality of compartment flow sensors and/or detecting a pressure drop associated with each of the compartments with a plurality of compartment pressure sensors. Adjusting the flow rate comprises adjusting the compartment flow controllers based at least in part on a bed depth of the agricultural products in each of the compartments.

In some embodiments adjusting the conditions of the air in each of the compartments may comprise adjusting a temperature of the air in each of the compartments with a plurality of temperature controllers. Further, controlling the conditions of the air in the unitary source plenum may comprise controlling a flow rate of the air in the unitary source plenum with a plenum flow controller. The method may also include detecting a speed of the air in the unitary source plenum with a plenum flow sensor and/or detecting a pressure of the air in the unitary source plenum with a plenum pressure sensor.

### BRIEF DESCRIPTION OF THE SEVERAL VIEWS OF THE DRAWING(S)

Having thus described the disclosure in general terms, reference will now be made to the accompanying drawings, which are not necessarily drawn to scale, and wherein:

FIG. 1 illustrates a sectional view through a two-pass dryer in accordance with an example embodiment of the present disclosure;

FIG. 2 illustrates a sectional view through a non-reversible single-pass dryer in accordance with an example embodiment of the present disclosure;

FIG. 3 illustrates a sectional view through a reversible single-pass dryer in accordance with an example embodiment of the present disclosure;

FIG. 4 illustrates a top view of the single-pass dryers of FIGS. 2 and 3 in accordance with an example embodiment of the present disclosure;

FIG. 5 illustrates a top view of an advanced single-pass dryer in accordance with an example embodiment of the present disclosure;

FIG. 6 illustrates a sectional view through the advanced single-pass dryer of FIG. 5 in accordance with an example embodiment of the present disclosure;

FIG. 7 illustrates a sectional view through a dryer including plenum conditioners and compartment conditioners in accordance with an example embodiment of the present disclosure;

FIG. 8 illustrates a top view of the dryer of FIG. 7 in accordance with an example embodiment of the present disclosure; and

FIG. 9 illustrates a method for drying a plurality of agricultural products in accordance with an example embodiment of the present disclosure.

### DETAILED DESCRIPTION

The present disclosure now will be described more fully hereinafter with reference to the accompanying drawings, in which some, but not all embodiments of the disclosure are shown. Indeed, the disclosure may be embodied in many different forms and should not be construed as limited to the embodiments set forth herein; rather, these embodiments are provided so that this disclosure will satisfy applicable legal requirements. Like numbers refer to like elements throughout.

When seed is harvested, the seed may have a higher moisture content than is required for safe storage. For example, corn seed may have a moisture content as high as forty-five percent when it is harvested from ears of corn. To ensure the corn is stored in a manner that maintains the viability of the corn seed, the seed may be dried to a moisture content of, for example, less than fourteen percent. Accordingly, seed dryers may be employed to dry seed to enhance the ability of the seed to be stored.

However, the rate of drying may have a significant impact on the viability and vigor of the seeds that are dried. For example, seed dried too rapidly may suffer from physiological impairment. Further, a number of factors may affect the rate at which seed dries, such as the moisture content of the seed, the humidity, temperature and flow rate of the drying air, and the seed's genotype. With regard to the seed's genotype, there may be a two-hundred percent difference in the drying rate of the slowest drying genotypes in comparison to the most rapid drying ones. Accordingly, dryers may include features intended to control the rate of drying of seed.

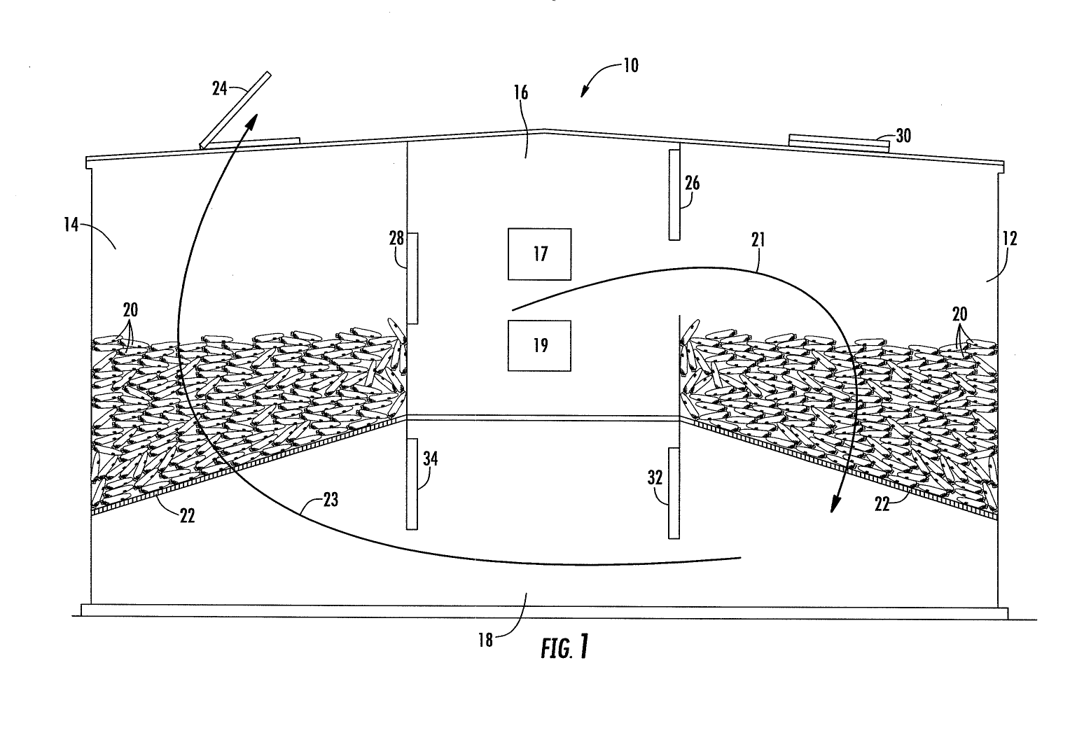

For example, FIG. 1 illustrates an embodiment of a two-pass dryer 10 configured to dry seeds. The two-pass dryer 10 may include first 12 and second 14 compartments disposed outside of an upper plenum 16 and a lower plenum 18. The upper plenum 16 may supply a source of relatively hot air (e.g., one hundred to one hundred and ten degrees Fahrenheit) at a relatively low humidity (e.g., ten to twenty percent relative humidity). The air in the upper plenum 16 may be provided by one or more fans 17 and heated by one or more burners 19 (e.g., natural gas or propane burners). Although schematically illustrated as being adjacent to one another, the burners 19 may operate in series with the fans 17 on the inlet side thereof such that pressurized hot air is directed into the upper plenum 16.

Within each of the compartments 12 and 14 is a volume of ear corn 20 which is stacked above an air permeable grate 22. In the example shown in FIG. 1, the corn 20 within the second compartment 14 has a higher moisture content than the corn in the first compartment 12. In this regard, the relatively hot air in the upper plenum 16 may be directed into the relatively dryer corn 20 in the first compartment 12, so as to avoid physiological damage to the corn in the second compartment 14 as a result of drying the corn too rapidly.

Thus, the relatively hot air from plenum 16 is introduced into the first compartment 12 and flows down through the corn 20 as shown by the downwardly directed arrow 21. The air traveling out of the plenum 16 into the first compartment 12 may be referred to as first pass air. This air passes through the grate 22 and into the lower plenum 18. The air in the lower plenum 18 is now at a cooler temperature and higher humidity than the air in the upper plenum 16 due to the air passing through the corn 20 in the first compartment 12. For example, the air in the lower plenum 18 may be between ninety to one hundred degrees Fahrenheit and twenty five to thirty five percent relative humidity as a result of passing through the corn 20 in the first compartment 12.

Air from the lower plenum 18 may then be introduced into the second compartment 14 and pass through the grate 22 and corn 20 and out through a door 24, as shown by the upwardly directed arrow 23. This air traveling from the lower plenum 18 through the second compartment 14 may be referred to as second pass air. By employing the second pass air, the relatively more moist corn 20 in the compartment 14 may be dried with relatively cooler and moister air in order to avoid damaging the corn by drying the corn too rapidly.

The two-pass dryer 10 may reverse the direction of flow to accommodate the moisture content of the corn 20 in the compartments 12, 14. In this regard, FIG. 1 illustrates air flow traveling from the upper plenum 16 through a door 26 into the first compartment 12 and ultimately exiting the second compartment 14 through the door 24. However, in an instance in which the corn 20 in the second compartment 14 is relatively more dry than the corn in the first compartment 12, the door 26 between the upper plenum 16 and the first compartment 12 may be closed and a door 28 between the upper plenum and the second compartment 14 may be opened such that the air flow travels from the upper plenum into the second compartment. Thereafter, the air may travel into the lower plenum 18, then up through the first compartment 12 and out a door 30.

Thus, by using the two-pass seed corn dryer 10, corn may be dried using two different temperatures and relative humidities. Additionally, the direction of the air flow may be controlled. Further, flow rates may be controlled via controlling the size of the openings defined by doors 32, 34 controlling flow into and out of the lower plenum 18. However, adjusting the doors may be a largely manual process, and hence adjustment may not occur often.

An additional embodiment of a dryer is that of a single-pass dryer. Single-pass dryers employ each volume of air once to dry corn, as opposed to twice as occurs in two-pass dryers as described above. In single-pass dryers, air may pass through a bed of corn (or other seed) once before being exhausted from the dryer. Single-pass dryers may be reversible or non-reversible. Non-reversible single-pass dryers allow air to travel through a bed of corn in only one direction (e.g., upwardly through the corn). Reversible single-pass dryers are configured to allow air to flow upwards or downwards through compartments filled with corn or other seed.

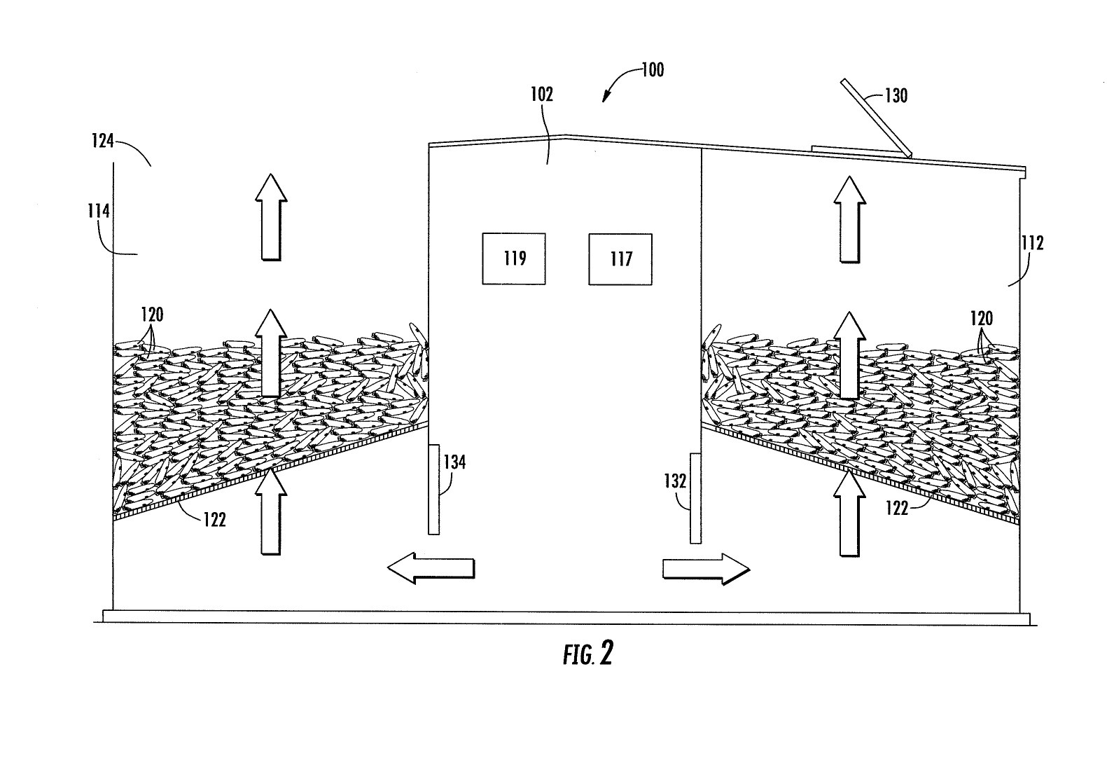

FIG. 2 illustrates an example embodiment of a non-reversible single-pass dryer 100. As illustrated, the single-pass dryer 100 may include a plenum 102 that is supplied air by one or more fans 117 and heated by one or more burners 119. Although schematically illustrated as being adjacent to one another, the burners 119 may operate in series with the fans 117 on the inlet side thereof such that pressurized hot air is directed into the plenum 102. Thereby, the air may travel through a pair of doors 132, 134 into first and second compartments 112, 114. The heated air may travel through air permeable grates 122 and corn 120 before exiting the single-pass dryer 100 through a roof fill door 130 or an opening 124 in the roof of the dryer 100.

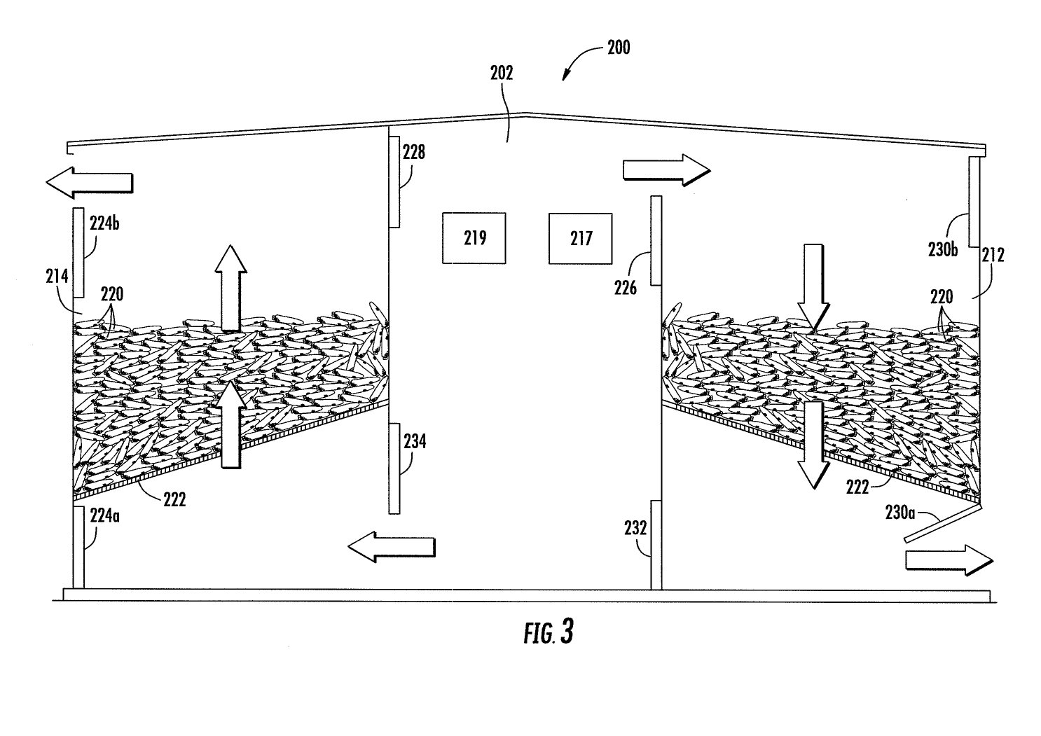

Further, FIG. 3 illustrates an example embodiment of a reversible single-pass dryer 200. As illustrated, the single-pass dryer 200 may include a plenum 202 that is supplied air by one or more fans 217 and heated by one or more burners 219. Although schematically illustrated as being adjacent to one another, the burners 219 may operate in series with the fans 217 on the inlet side thereof such that pressurized hot air is directed into the plenum 202. Thereby, the air may travel from the plenum 202 through an upper inlet door 226 into a first compartment 212, down through corn 220 and an air permeable grate 222 before exiting the single-pass dryer 200 through a lower exhaust door 230a. However, flow through the first compartment 212 may be reversed such that air enters from the plenum 202 through a lower inlet door 232 and travels up through the air permeable grate 222 and corn 220 and out through an upper outlet door 230b. In this configuration, the upper inlet door 226 and the lower exhaust door 230a may be closed.

For example, FIG. 3 illustrates upward flow through a second compartment 214. In particular air flow from the plenum 202 enters the second compartment 214 through a lower inlet door 234, travels up through a grate 222 and corn 220 and out through an upper exhaust door 224b. However, flow through the second compartment 214 may also be reversed. In this regard, the lower inlet door 234 and the upper exhaust door 224b may instead be closed and the upper inlet door 228 and the lower exhaust door 224a may be opened to provide for a downward flow through the corn 220. Thus, by flowing air through the corn 220 in two directions, drying of the seed may occur in an improved manner such that both the top and bottom portions seed are dried relatively evenly. In contrast, a non-reversible single-pass dryer (e.g., as illustrated in FIG. 2) may dry one side (e.g., the bottom) of the corn more than the other side (e.g., the top).

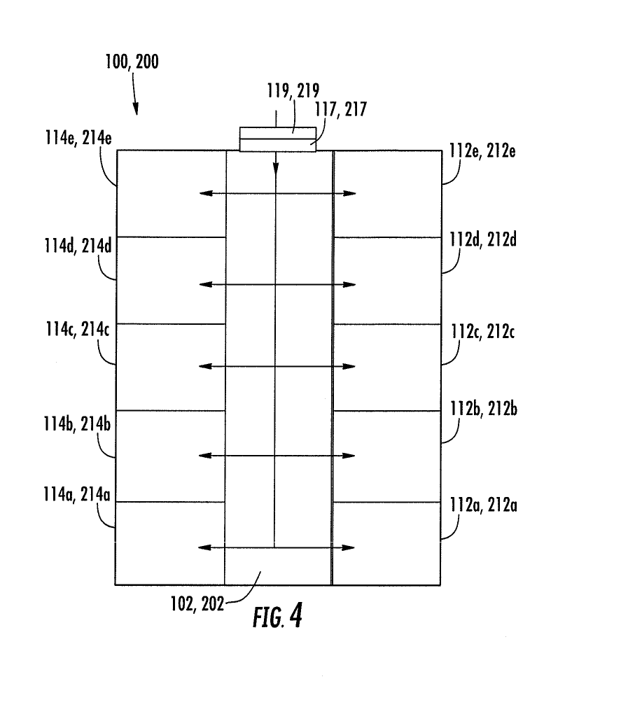

Single-pass dryers may be referred to as either “simple” or “advanced.” FIGS. 2 and 3 illustrate simple single-pass dryers 100, 200. As illustrated in FIG. 4, which schematically illustrates a top view of the seed dryer 100 of FIG. 2 and the seed dryer 200 of FIG. 3, simple single-pass dryers may employ a single plenum 102, 202, to supply air to each of a plurality of compartments 112a-e, 114a-e, 212a-e, 214a-e. Accordingly, each of the compartments 112a-e, 114a-e, 212a-e, 214a-e may receive air at substantially the same temperature, which may cause the seed to be dried too quickly or too slowly as the single supply of heated air does not allow for individual control within the compartments to accommodate differences in the seed therein. Thus, Applicant has identified that simple single-pass dryers may not allow the drying process to be adequately controlled to optimize efficiency and maximize quality in terms of the rate of drying.

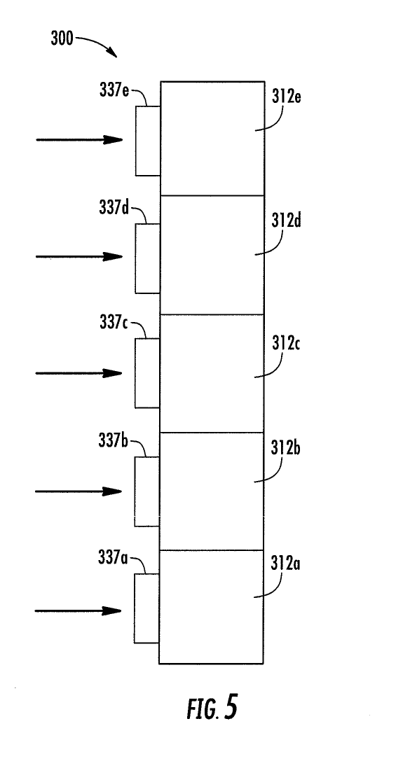

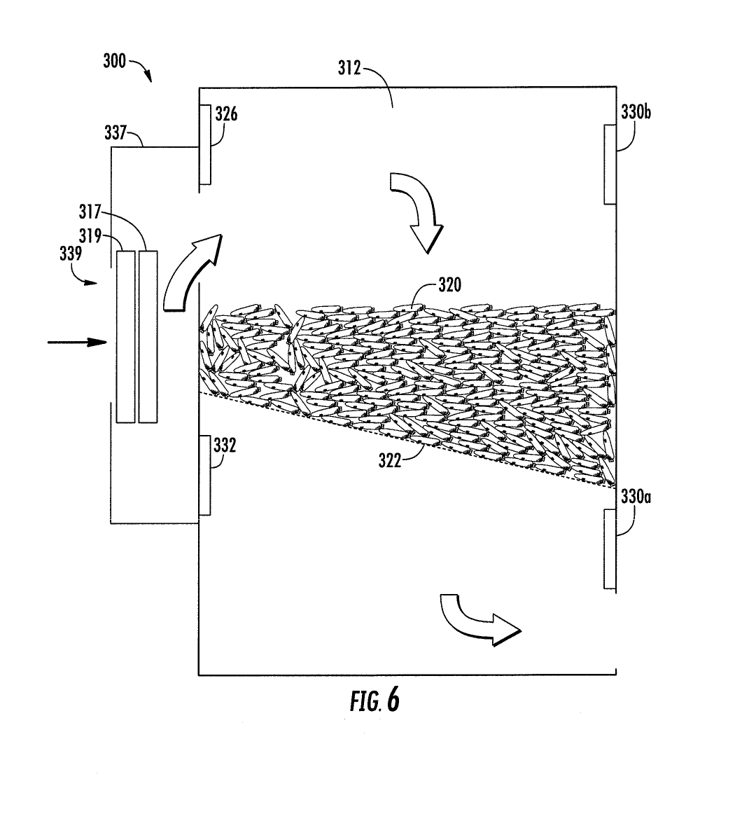

Advanced single-pass dryers include features configured to avoid these problems. In this regard, FIGS. 5 and 6 illustrate top and cross-sectional views of an example embodiment of an advanced single-pass seed dryer 300. As illustrated in FIG. 5, the seed dryer 300 may supply air to each of a plurality of compartments 312a-e through respective air supply units 337a-e. As illustrated in FIG. 6, each air supply unit 337 may comprise a burner 319 (e.g., a natural gas or propane burner). The burner 319 may alternatively comprise a heat exchanger supplied with hot water from a boiler in some embodiments. Further, each air supply unit 337 may include a fan 317. Thereby, some individual control of temperature and air flow rate may be possible for each compartment 302.

The advanced seed dryer 300 is illustrated as being reversible. In this regard, each air supply unit 337 may receive air from an ambient environment through an inlet opening 339 and heat the air with the burner 319 (or heat exchanger). The fan 317 may then direct the heated air through an upper inlet door 326 into the compartment 312 such that the air travels downwardly through the corn 320 and grate 322 and then out a lower outlet door 330a. Alternatively, the upper inlet door 326 and the lower outlet door 330a may be closed, and the air may travel through a lower inlet door 332 into the compartment 312, up through the grate 322 and corn 320, and out through an upper outlet door 330b.

Accordingly, the advanced seed dryer 300 may provide individual control of the drying in each of the compartments 312a-e. However, control of flow rate and temperature for each compartment 312a-e may suffer from implementation problems. For example, each fan 317 may be controlled by a variable frequency drive that allows the speed of a motor driving the fan 317 to be adjusted only within a certain range (e.g., between one hundred percent, which may correspond to sixty hertz and fifty percent, which may correspond to thirty hertz). Further, the decrease in rotation speed of the fan 317 may not correspond to an equivalent decrease in air flow rate (e.g., a fifty percent decrease in motor and fan speed may correspond to a lesser decrease in air flow rate). Further, the burners 319 may require that a flame remain lit at all times, which may preclude use of the burners to affect small increases in temperature. Additionally, use of individual fans 317 and burners 319 with each of the compartments 312a-e may increase the cost of the seed dryer 300 significantly in terms of initial equipment purchases, maintenance expenses, and repair expenses. Similarly, use of a boiler and individual heat exchangers 319 may require purchase of a large capacity boiler in order to account for the possibility of cooler weather despite normal conditions requiring less heating capacity, which may also increase costs. Accordingly, Applicant has identified disadvantages associated with the above-described embodiments of dryers.

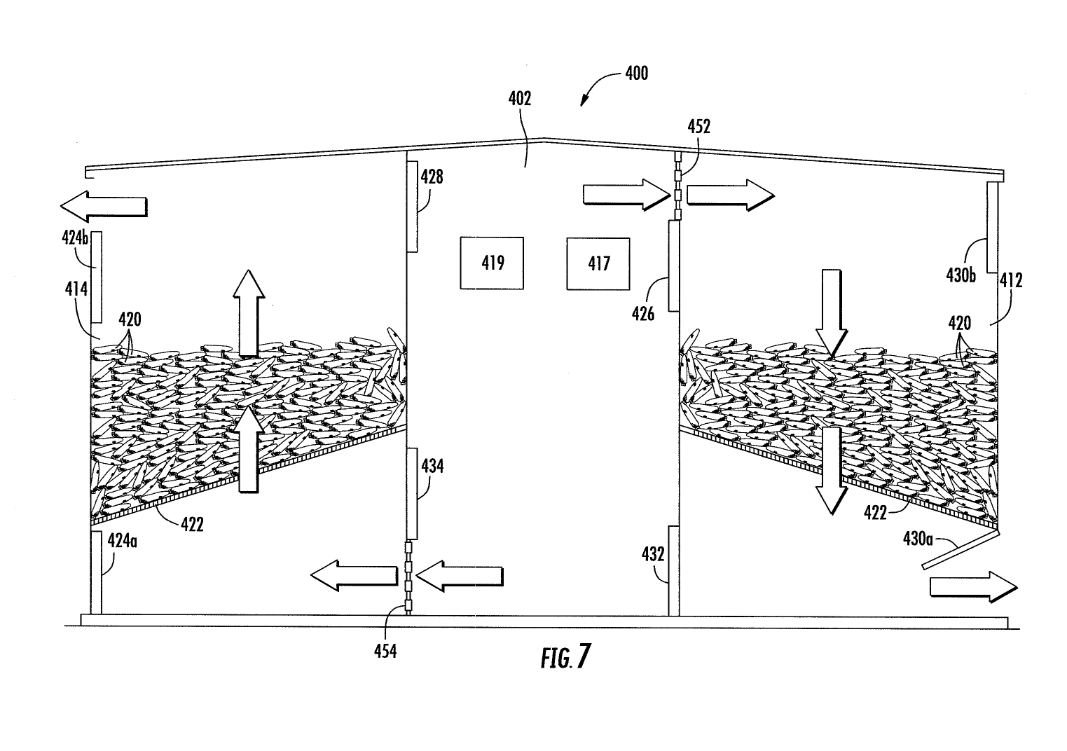

Thus, Applicant herein provides embodiments of an improved dryer 400, as illustrated in FIG. 7. The dryer 400 may be employed to dry seed (e.g., corn seed) in some embodiments. Thus, although the dryer 400 is generally described herein as drying corn, this description is provided only for example purposes. In this regard, the dryer 400 may be employed to dry various other agricultural and non-agricultural products in other embodiments.

As illustrated, the dryer 400 may include a plurality of compartments 412, 414 configured to contain agricultural products. In the illustrated embodiment, the compartments 412, 414 are filled with corn 420, which rests on a grate 422 or other air permeable structure. One or more fans 417 are configured to produce a flow of air. A unitary source plenum 402 may be configured to receive the air and selectively supply the air to each of the compartments 412, 414, as will be described below. The terms “unitary” and “source,” as used herein to describe the plenum 402, refer to the plenum's configuration whereby the plenum may supply air to each of the compartments without first supplying the air to other compartments. In this regard, the dryer 400 is a single-pass dryer, as opposed to a two-pass dryer wherein the air supplied from the plenum travels through one compartment prior to entering another compartment.

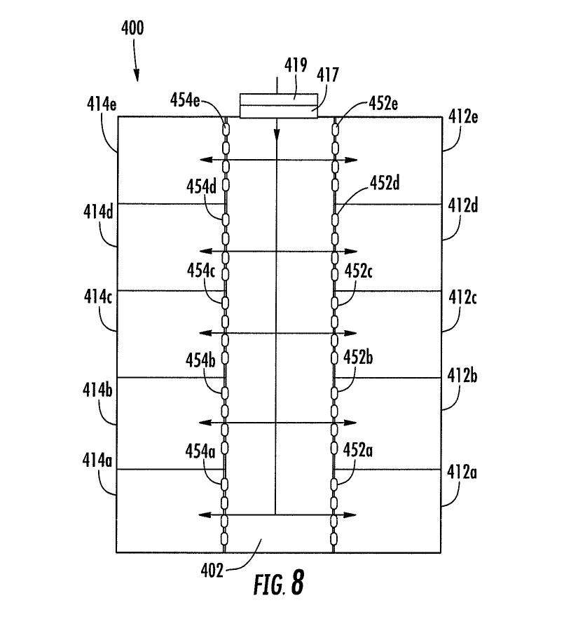

One or more plenum conditioners 419 may be configured to control one or more conditions of the air in the unitary source plenum 402 and received by the compartments 412, 414. Although schematically illustrated as being adjacent to one another in FIG. 7, the plenum conditioners 419 may operate in series with the fans 417 on the inlet side thereof such that pressurized conditioned air is directed into the unitary source plenum 402, as illustrated in FIG. 8. However, the plenum conditioners 419 may be positioned and configured differently relative to the fans 417 in other embodiments.

The plenum conditioners 419 may comprise a heater in some embodiments. In this regard, one of the conditions controlled by the plenum conditioner 419 may comprise a temperature of the air in the unitary source plenum 402 and received by the compartments 412, 414. The heater may be configured to increase the temperature of the air in the unitary source plenum 402 and received by the compartments 412, 414 to a minimum desired temperature for the compartments. The heater may comprise a burner (e.g., a natural gas or propane burner) or a boiler and a heat exchanger in some embodiments, although various other embodiments of heaters may be employed.

As illustrated in the top view of FIG. 8, the unitary source plenum 402 may supply air to each of the compartments 412a-e, 414a-e. Note that although the dryer 400 is illustrated as including ten compartments 412a-e, 414a-e, the dryer may include various other numbers of compartments in other embodiments (e.g., twenty four in some embodiments). In embodiments in which the plenum conditioner 419 comprises a heater, the heater may heat the air in the unitary source plenum 402 to a lowest desired temperature of all of the compartments. For example, if one compartment (e.g., compartment 412a) has relatively more moist corn 420 than the remaining compartments (e.g., compartments 412b-e, 414a-e), it may be desirable to dry the corn in that compartment (e.g., compartment 412a) with air having a relatively lower temperature than the air used to dry the corn in the other compartments (e.g., compartments 412b-e, 414a-e) to avoid drying the corn in a manner that is too rapid, which could potentially damage the corn as described above. Thus, the plenum conditioner 419 may employ the heater to heat the air in the unitary source plenum 402 to the minimum desired temperature of the compartments (e.g., the desired temperature of compartment 412a). Accordingly, the temperature of the air provided to each of the compartments 412, 414 may not exceed the desired temperature for each of the compartments. Further, the temperature may be adjusted at each of the compartments 412, 414 to optimize drying, as will be discussed below.

In some embodiments the plenum conditioners 419 may additionally or alternatively comprise a humidity control unit. Thereby, one of the conditions controlled by the humidity control unit, and thereby the plenum conditioner 419, may comprise a specific humidity of the air in the unitary source plenum 402 and received by the compartments 412, 414. The humidity control unit may be configured to reduce the specific humidity to a desired plenum humidity. For example, the humidity control unit may comprise a dehumidifier.

In embodiments in which the plenum conditioner 419 comprises a humidity control unit, the humidity control unit may decrease the specific humidity in the unitary source plenum 402 to the highest desired specific humidity of all of the compartments. For example, if one compartment (e.g., compartment 412a) has relatively more moist corn 420 than the remaining compartments (e.g., compartments 412b-e, 414a-e), it may be desirable to dry the corn in that compartment (e.g., compartment 412a) with air having a relatively higher specific humidity than the air used to dry the corn in the other compartments (e.g., compartments 412b-e, 414a-e) to avoid drying the corn in a manner that is too rapid, which could potentially damage the corn. Thus, the plenum conditioner 419 may employ the humidity control unit to decrease the humidity of the air in the unitary source plenum 402 to a desired plenum humidity corresponding to the highest desired specific humidity of each of the compartments (e.g., the desired specific humidity of compartment 412a). Accordingly, the specific humidity of the air provided to each of the compartments 412, 414 may be set to the lowest specific humidity that is useable for each of the compartments and hence drying may occur without damaging the corn 420 while still reducing the humidity so that the corn may be dried more rapidly than otherwise may occur. Further, the humidity may be adjusted at each of the compartments 412, 414 to optimize drying, as will be discussed below.

Alternatively or additionally, the humidity control unit may be configured to increase the specific humidity to the desired plenum humidity. For example, the humidity control unit may comprise a humidifier. In one example embodiment, the humidifier may include a screen or other porous media with water directed thereto such that the air directed through the humidifier includes additional moisture relative to the ambient air.

Thus, in embodiments of the plenum conditioner 419 configured to increase the specific humidity to the desired plenum humidity, the humidity control unit may increase the specific humidity in the unitary source plenum 402 to the highest desired specific humidity of all of the compartments. Accordingly, as described above, the specific humidity of the air provided to each of the compartments 412, 414 may be set to the lowest specific humidity that is useable for each of the compartments and hence drying may occur without damaging the corn 420. Further, the humidity may be adjusted at each of the compartments 412, 414 to optimize drying, as will be discussed below.

Further, in some embodiments the plenum conditioner 419 may comprise a plenum flow controller. For example, the plenum flow controller may comprise a variable frequency drive configured to control the speed of one or motors driving the one or more fans 417, variable pulleys configured to control the speed of the fans, or any other electrical mechanical, or electromechanical device configured to control the rotational speed of the fans. In addition to varying the speed of the fan(s) 417, the plenum flow controller may turn the fan(s) on or off to control the flow of air into the unitary source plenum 402. Alternatively or additionally, the flow controller may comprise a gate, door, or other device configured to restrict the flow of air into or out of the fans 417 or the unitary source plenum 402. Accordingly, one of the conditions controlled by the plenum flow controller, and thereby the plenum conditioner 419, may comprise the flow rate of the air in the unitary source plenum 402. Thus, the flow of air in the unitary source plenum 402 may be adjusted, for example, to account for the number of compartments 412, 414 presently in use and the type and quantity of products therein.

Further, the dryer 400 may include a plenum flow sensor configured to detect a speed of the air in the unitary source plenum 402. In another embodiment dryer 400 may comprise a plenum pressure sensor configured to detect a pressure of the air in the unitary source plenum 402. Accordingly, the dryer 400 may determine and control the flow rate and/or pressure in the unitary source plenum 402 to achieve a desired flow rate and/or a desired pressure in the plenum. Thereby, for example, the plenum flow controller may adjust the flow rate of the air in the plenum based on a maximum desired flow rate for each of the compartments 412, 414, and the flow rate may be lowered at the compartments as necessary (as will be discussed below). However, in other example embodiments, the plenum flow controller may adjust the plenum flow rate based on an average desired flow rate or a minimum desired flow rate for each of the compartments 412, 414 and the flow rate may be increased at the compartments as necessary (as will be discussed below).

Thus, as described above, one or more plenum conditioners 419 may be employed to control one or more conditions of the air in the unitary plenum 402. As further noted above, the plenum conditioners 419 may condition the air such that the air in the unitary source plenum 402 defines a desired temperature, desired specific humidity, desired pressure, and/or a desired air flow rate. In this regard, the plenum conditioners 419 may include various combinations of a heater, dehumidifier, humidifier, and/or plenum flow controller as described above. Thus, by employing one or more plenum conditioners 419, the air received from the unitary source plenum 402 by the compartments 412, 414 may be conditioned to a state useable to dry the corn 420 (or other products) in the compartments without causing damage thereto.

Further, by employing the unitary source plenum 402, which selectively supplies air to each of the compartments 412, 414, efficiencies may be achieved in terms of energy expended in controlling the properties of the air prior to entering the compartments 412, 414. In this regard, relatively larger scale heaters, dehumidifiers, humidifiers, and/or flow controllers may be employed, which may benefit from economies of scale. For example, the heaters may comprise relatively large burners which may be less costly and more efficient than small-scale burners or heat exchangers. Thereby, the air entering the compartment 412, 414 may be pre-conditioned in a relatively efficient manner.

However, as noted above, use of single source of conditioned air for each compartment may not optimize the drying process for each compartment. In this regard, although use of a single source of air may prevent too rapid of drying of corn 420 (or other agricultural or non-agricultural products) in some compartments, use of a single source of conditioned air may prevent optimization of drying of the seeds in other compartments.

In order to provide for improved drying within each of the compartments 412, 414, the dryer 400 may further comprise a plurality of compartment conditioners 452, 454. The compartment conditioners 452, 454 may be configured to respectively adjust one or more of the conditions of the air in each of the compartments 412, 414. In the illustrated embodiment, air travels from the unitary source plenum 402 to the first compartment 412 through an upper door 426 in which a first compartment conditioner 452 is positioned, through the corn 420 and air permeable grate 422, then out through a lower outlet door 430a. However, the air may alternatively enter from the unitary source plenum 402 through a lower door 432 (in which a compartment conditioner may be positioned), up through the grate 422 and corn 420, and out through an upper door 430b. For example, the second compartment 424 is illustrated as receiving the air through a lower door 434 in which a compartment conditioner 454 is positioned, and the air exits through an upper door 424b. However, the flow may also be reversed in the second compartment 414 such that flow enters from the unitary source plenum 428 through an upper door 428 (in which a compartment controller may be positioned) and exit through a lower door 424a.

In one embodiment, the compartment conditioners 452, 454 may comprise a plurality of compartment flow controllers. Compartment flow controllers may comprise a gate, door, or other device configured to restrict the flow into the compartments 412, 414. Accordingly, the rate of flow into the compartments 412, 414 may be reduced to the desired flow rate. For example, the fans 417 may be directed to produce a flow rate of air into the unitary source plenum 402 that is greater than or equal to the maximum flow rate of each of the compartments 412, 414. Thereby, the compartment flow controllers may reduce the flow rate as needed to the desired flow rate through each of the compartments 412, 414. In one example embodiment, the doors 426, 432, 428 434 connecting the unitary source plenum 402 to the compartments 412, 414 may control the flow rate into the compartments.

However, in other embodiments the compartment controllers may additionally or alternatively comprise fans configured to increase the flow of air into the compartments 412, 414. The compartment flow controllers may include a variable frequency drive configured to control the speed of a motor driving the fans, variable pulleys configured to control the speed of the fans, or any other electrical or mechanical device configured to control the rotational speed of the fans. Accordingly, the flow rate through the compartments may be increased using the fans as necessary to achieve the desired flow rate in embodiments in which the fans 417 produce a flow rate below the highest desired flow rate of the containers 412, 414. However, this embodiment may provide additional complexity and cost as compared to an embodiment that reduces the flow rate into the compartments 412, 414 (as necessary), as described above.

Accordingly, the conditions adjusted by the compartment flow controllers may comprise a flow rate of the air into each of the compartments 412, 414. The dryer 400 may include compartment flow sensors configured to detect the speed of the air supplied to each the compartments 412, 414. Thus, the speed of the air at each of the compartments 412, 414 may be known.

In another embodiment, the dryer 400 may additionally or alternatively comprise compartment pressure sensors configured to detect the pressure drop associated with each of the compartments 412, 414. The pressure drop information may be used to determine the flow rates of the air into or through the compartments 412, 414. For example, the pressure sensors may measure the pressure in each of the compartments 412, 414 and compare these pressures to the pressure in the unitary source plenum 402. Thereby, the pressure drop across the compartment flow controller may be determined. The compartment flow controllers may be configured to adjust the flow rate in the compartments 412, 414 based at least in part on a bed depth or other measure of the agricultural products (e.g., the corn 420) or non-agricultural products in each of the compartments. Accordingly, the compartment flow controllers may adjust the flow rates into each of the compartments 412, 414 to account for the pressure drop associated with forcing the air through the corn 420 (or other products).

In some embodiments the compartment conditioners 452, 454 may additionally or alternatively comprise a plurality of temperature controllers. Thus, the conditions adjusted by the temperature controllers may comprise a temperature of the air in each of the compartments 412, 414. As noted above, the plenum conditioner 419 may include a heater configured to heat the air in the unitary source plenum 402. However, the heater may be configured to heat the air in the unitary source plenum 402 to a minimum desired temperature for the compartments 412, 414 so as to avoid drying relatively more moist corn 420 (or other agricultural or non-agricultural produces) too rapidly. In this regard, the temperature of the air in the unitary source plenum 402 may be lower than is desirable for some of the compartments 412, 414. For example, compartments that contain corn 420 (or other agricultural or non-agricultural product) that is relatively more dry may benefit from warmer air that may allow the product to be dried more rapidly. Accordingly, the temperature controllers may be configured to heat the air received by the compartments 412, 414 as is necessary to reach desired temperatures and thereby drying may be optimized for each of the individual compartments. In one embodiment the temperature controllers may comprise heat exchangers that receive heated fluid from a boiler, although burners or other heating devices may be employed in other embodiments.

Thus, as described above, the compartment conditioners may optimize the conditions of the air that is pre-conditioned by the plenum conditioners. In some embodiments the plenum conditioner 419 and/or the compartment conditioners 452, 454 or a separate portion of the dryer 400 may include a dryer control system configured to determine the minimum desired temperature for the compartments 412, 414. For example, the dryer control system may predict the moisture of the corn 420 (or other agricultural or non-agricultural products) within the compartments 412, 414. The dryer control system may predict the moisture of the corn 420 (or other agricultural or non-agricultural products) per depth within the compartments 412, 414 and/or on average for all of the products in each compartment.

Thereby, the temperature, humidity and flow rate in the unitary source plenum 402 may be controlled to achieve optimum drying without drying any of the corn 420 (or other products) in the compartments 412, 414 too quickly. In this regard, the plenum conditioners 419 may select the temperature in the unitary source plenum 402 (as well as other factors such as flow rate and humidity) to achieve, for example, a one percent moisture loss every three and one half to four and one half hours for corn 420, which may bring about relatively rapid drying of the corn without causing damage thereto. The selected drying parameters (e.g., temperature, humidity, and flow rate) may be based on information entered by an operator or detected by the dryer 400, including, for example, the genotype or other identifying information regarding the agricultural or non-agricultural products being dried, the initial moisture content of the agricultural or non-agricultural products when placed in the compartments 412, 414, and the fill depth or other measure of the agricultural or non-agricultural products in the compartments. These factors may be considered for each individual compartment 412, 414 such that the drying parameters account for differences between the agricultural or non-agricultural products in each of the compartments.

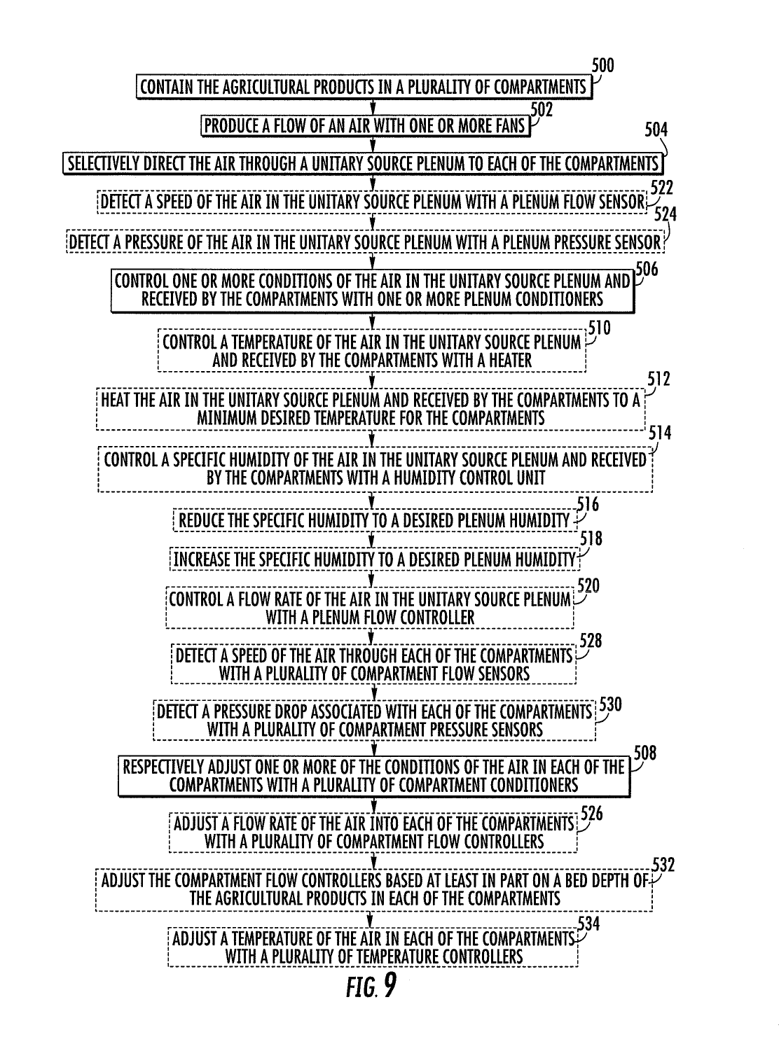

Embodiments of methods for drying agricultural or non-agricultural products are also provided. The methods may employ the above-described dryer 400 in some embodiments. As illustrated in FIG. 9, in one embodiment a method for drying agricultural or non-agricultural products may comprise containing the agricultural (or non-agricultural) products in a plurality of compartments at operation 500. Further, the method may include producing a flow of an air with one or more fans at operation 502. Additionally, the method may include selectively directing the air through a unitary source plenum to each of the compartments at operation 504. Also, the method may include controlling one or more conditions of the air in the unitary source plenum and received by the compartments with one or more plenum conditioners at operation 506. The method may further comprise respectively adjusting one or more of the conditions of the air in each of the compartments with a plurality of compartment conditioners at operation 508.

In some embodiments the method may additionally or alternatively comprise other operations including those operations illustrated in dashed lines in FIG. 9. For example controlling the conditions of the air in the unitary source plenum at operation 506 may comprise controlling a temperature of the air in the unitary source plenum and received by the compartments with a heater at operation 510. Controlling the temperature of the air in the unitary source plenum at operation 510 may comprise heating the air in the unitary source plenum and received by the compartments to a minimum desired temperature for the compartments at operation 512.

In a further embodiment, controlling the conditions of the air in the unitary source plenum at operation 506 may comprise controlling a specific humidity of the air in the unitary source plenum and received by the compartments with a humidity control unit at operation 514. Further, controlling the specific humidity at operation 514 may comprise reducing the specific humidity to a desired plenum humidity at operation 516 or increasing the specific humidity to a desired plenum humidity at operation 518. Additionally, controlling the conditions of the air in the unitary source plenum at operation 506 may comprise controlling a flow rate of the air in the unitary source plenum with a plenum flow controller at operation 520. The method may further comprise detecting one or more of the conditions of the air in the unitary source plenum. For example, the method may further comprise detecting a speed of the air in the unitary source plenum with a plenum flow sensor at operation 522 and/or detecting a pressure of the air in the unitary source plenum with a plenum pressure sensor at operation 524.

Additionally, adjusting the conditions of the air in each of the compartments at operation 508 may comprise adjusting a flow rate of the air into each of the compartments with a plurality of compartment flow controllers at operation 526. The method may further comprise detecting one or more of the conditions of the air in each of the compartments. For example, the method may further comprise detecting a speed of the air through each of the compartments with a plurality of compartment flow sensors at operation 528 and/or detecting a pressure drop associated with each of the compartments with a plurality of compartment pressure sensors at operation 530. In some embodiments adjusting the flow rate at operation 526 may comprise adjusting the compartment flow controllers based at least in part on a bed depth of the agricultural products in each of the compartments at operation 532. Further, in some embodiments adjusting the conditions of the air in each of the compartments at operation 508 may comprise adjusting a temperature of the air in each of the compartments with a plurality of temperature controllers at operation 534.

Accordingly, embodiments of the dryer and associated method discussed herein may provide benefits over other embodiments of single-pass and two-pass dryers. In particular, embodiments of the dryer may pre-condition air and distribute the air to a plurality of compartments using a unitary source plenum. By pre-conditioning and distributing air in this manner, the dryer may take advantage of relatively larger scale plenum conditioners (e.g., heaters, dehumidifiers, humidifiers, and flow controllers), which may reduce costs and increase efficiency relative to smaller scale units. The pre-conditioned air may then be adjusted using compartment conditioners so as to optimize the drying conditions in each of the compartments. Thus, the dryer and associated methods may optimize drying for each compartment while taking advantage of economies of scale.

Many modifications and other embodiments of the disclosure set forth herein will come to mind to one skilled in the art to which the disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A dryer configured to dry a plurality of agricultural products, the dryer comprising:
a plurality of compartments configured to contain the agricultural products;
one or more fans configured to produce a flow of an air;
a unitary source plenum configured to receive the air and selectively supply the air to each of the compartments;
one or more plenum conditioners configured to control one or more conditions of the air in the unitary source plenum and received by the compartments; and
a plurality of compartment conditioners configured to respectively adjust one or more of the conditions of the air in each of the compartments.

2. The dryer of claim 1, wherein the plenum conditioners comprise a heater and the one of the conditions controlled by the heater comprises a temperature of the air in the unitary source plenum and received by the compartments.

3. The dryer of claim 2, wherein the heater is configured to increase the temperature of the air in the unitary source plenum and received by the compartments to a minimum desired temperature for the compartments.

4. The dryer of claim 1, wherein the plenum conditioners comprise a humidity control unit and the one of the conditions controlled by the humidity control unit comprises a specific humidity of the air in the unitary source plenum and received by the compartments.

5. The dryer of claim 4, wherein the humidity control unit is configured to reduce the specific humidity to a desired plenum humidity.

6. The dryer of claim 4, wherein the humidity control unit is configured to increase the specific humidity to a desired plenum humidity.

7. The dryer of claim 1, wherein the compartment conditioners comprise a plurality of compartment flow controllers and the one of the conditions adjusted by the compartment flow controllers comprises a flow rate of the air into each of the compartments.

8. The dryer of claim 7, further comprising a plurality of compartment flow sensors configured to detect a speed of the air supplied to each of the compartments.

9. The dryer of claim 7, further comprising a plurality of compartment pressure sensors configured to detect a pressure drop associated with each of the compartments.

10. The dryer of claim 9, wherein the compartment flow controllers are configured to adjust the flow rate based at least in part on a bed depth of the agricultural products in each of the compartments.

11. The dryer of claim 1, wherein the compartment conditioners comprise a plurality of temperature controllers and the one of the conditions adjusted by the temperature controllers comprises a temperature of the air in each of the compartments.

12. The dryer of claim 1, wherein the plenum conditioners comprise a plenum flow controller and the one of the conditions controlled by the plenum flow controller comprises a flow rate of the air in the unitary source plenum.

13. The dryer of claim 12, further comprising a plenum flow sensor configured to detect a speed of the air in the unitary source plenum.

14. The dryer of claim 12, further comprising a plenum pressure sensor configured to detect a pressure of the air in the unitary source plenum.

15. A method for drying a plurality of agricultural products, comprising:
containing the agricultural products in a plurality of compartments;
producing a flow of an air with one or more fans;
selectively directing the air through a unitary source plenum to each of the compartments;
controlling one or more conditions of the air in the unitary source plenum and received by the compartments with one or more plenum conditioners; and
respectively adjusting one or more of the conditions of the air in each of the compartments with a plurality of compartment conditioners.

16. The method of claim 15, wherein controlling the conditions of the air in the unitary source plenum comprises controlling a temperature of the air in the unitary source plenum and received by the compartments with a heater.

17. The method of claim 16, wherein controlling the temperature of the air in the unitary source plenum comprises heating the air in the unitary source plenum and received by the compartments to a minimum desired temperature for the compartments.

18. The method of claim 15, wherein controlling the conditions of the air in the unitary source plenum comprises controlling a specific humidity of the air in the unitary source plenum and received by the compartments with a humidity control unit.

19. The method of claim 18, wherein controlling the specific humidity comprises reducing the specific humidity to a desired plenum humidity.

20. The method of claim 19, wherein controlling the specific humidity comprises increasing the specific humidity to a desired plenum humidity.

21. The method of claim 15, wherein adjusting the conditions of the air in each of the compartments comprises adjusting a flow rate of the air into each of the compartments with a plurality of compartment flow controllers.

22. The method of claim 21, further comprising detecting a speed of the air through each of the compartments with a plurality of compartment flow sensors.

23. The method of claim 21, further comprising detecting a pressure drop associated with each of the compartments with a plurality of compartment pressure sensors.

24. The method of claim 23, wherein adjusting the flow rate comprises adjusting the compartment flow controllers based at least in part on a bed depth of the agricultural products in each of the compartments.

25. The method of claim 15, wherein adjusting the conditions of the air in each of the compartments comprises adjusting a temperature of the air in each of the compartments with a plurality of temperature controllers.

26. The method of claim 15, wherein controlling the conditions of the air in the unitary source plenum comprises controlling a flow rate of the air in the unitary source plenum with a plenum flow controller.

27. The method of claim 26, further comprising detecting a speed of the air in the unitary source plenum with a plenum flow sensor.

28. The method of claim 26, further comprising detecting a pressure of the air in the unitary source plenum with a plenum pressure sensor.
